(19) United States
(12) Patent Application Publication
(10) Pub. No.: US 2002/0178001 A1
(43) Pub. Date: Nov. 28, 2002

(54) Telecommunication apparatus and methods

(76) Inventors: Jeffrey A. Balluff, Boise, ID (US); Robert Sesek, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/864,738

(22) Filed: May 23, 2001

(51) Int. Cl. G10L 15/26

(52) U.S. Cl. 704/235

(57) ABSTRACT

Methods and apparatus for communicating information between two individuals engaged in a conversation via a telecommunication network. A first signal is received from a first individual in voice format. A second signal is received from a second individual in voice format. The first and second signals are automatically converted from voice format into text format. The first and second signals are also visually displayed as text to allow the first individual to listen to, as well as to substantially simultaneously read, the words spoken by both individuals.

### FIELD OF THE INVENTION

This invention pertains to telecommunications apparatus and methods and more specifically to telecommunications apparatus and methods for use in providing customer support services.

### BACKGROUND OF THE INVENTION

Often, various organizations maintain support staff to provide support services to various customers. These support services can be, for example, technical support services as in the case of a manufacturer or seller of various industrial or consumer products. In such a case, the manufacturer or seller of the products often provides support services to customers who are users of its products. Such support services are generally provided for the purpose of assisting the customer in resolving problems relating to the product. As a specific example, a typical computer software seller often maintains a customer support group to provide technical support to users of its software wherein the support group assists the software users in solving problems related to the use of the software.

Support services are not only provided by product-oriented organizations, but are also provided by service organizations such as those involved in providing banking, transportation, and telecommunication services. In such cases, support groups are maintained by the service organizations to assist customers of the organization with problems regarding the services provided by the organization. As a specific example, a typical banking company often maintains a support group which assists customers regarding problems or questions relating to the banking services provided by the company.

Support groups are also maintained by public organizations such governmental agencies and the like. Furthermore, the support services provided by a support group can be targeted toward customers who are also members of the organization. That is, a “customer” can include individuals or entities which are a part of the organization which maintains the support group as well as individuals or entities which are external to the organization. For example, a typical large municipality often maintains at least one technical support group to provide technical customer support to various municipal employees and municipal departments regarding problems encountered with equipment and the like which is owned or operated by the municipality.

In many cases, a support group is located in a central location such as at the organization's headquarters or at a technical center or the like maintained by the organization. Generally, the support services are provided to customers by way of a telephone network. That is, the support group generally provides its customers with at least one telephone number, such as a toll-free telephone number or the like. The customers can then call the telephone number provided by the support group to receive support assistance. For example, purchasers of computer software are sometimes provided with a toll-free telephone number which can be called to obtain assistance in the event that problems are encountered with the use of the software.

In an effort to provide better customer support, as well as to provide better products or services, support groups often employ tracking systems to record and track data relating to the support services provided by the support groups. Such tracking systems can include, for example, personal computers which employ specialized programs to record data entered into the computer by a member of the support staff. Thus, in many cases, support group staff members are often supplied with a telephone as well as a personal computer, or the like, for use as a tracking system. The computers operated by the support group are, in some cases, connected to a local computer network.

Moving now to FIG. 1, a simplified schematic diagram is shown which depicts a typical prior art configuration of a customer support system 10. The prior art customer support system 10 typically comprises a personal computer 15 which includes a manual keypad 17 or the like for manually entering data into the computer. The customer support system also typically comprises a telephone device 20 such as a telephone handset or a telephone headset. The telephone device 20 is typically connected to a telecommunications network 25.

The support staff member “S” receives telephone calls from customers such as customer “C” who request support services. The customer “C” calls the support staff member “S” over the telecommunications network 25. When the staff member “S” receives a telephone call from the customer “C” the staff member and the customer engage in a conversation over the telecommunications network. While engaged in the conversation with the customer “C” the staff member “S” often must manually enter data into the computer 15 by way of the keypad 17.

Such data which is manually entered into the computer 15 by the staff member “S” often includes data which is obtained directly from the customer “C” during the conversation by way of the telecommunications network 25. That is, during the conversation between the staff member “S” and the customer “C,” the customer relays information regarding the customer's question, problem, or concern to the staff member by speaking to the staff member. Also, the staff member “S” typically queries the customer “C” regarding the customer's concern or problem in order to obtain specific information.

For example, in the case of a problem with a product, the staff member “S” typically asks the customer “C” for the model number and serial number of the product in question. The customer “C” typically relays this information to the staff member “S” by speaking to the staff member and telling the staff member the model number and serial number of the product in question. Upon hearing the customer “C” speak the model number and serial number, the staff member “S” then typically enters the model number and serial number into the computer 15. Other data which is typically entered into the computer 15 by the staff member “S” in this manner can include the name of the customer “C” as well as the address and telephone number of the customer “C” and the date and place of purchase of the product in question.

The staff member “S” and customer “C” often typically engage in a detailed conversation in which the staff member attempts to ascertain the exact nature of the problem which the customer is having. In such a conversation, the staff member “S” can ask specific questions of the customer “C” or the staff member can simply allow the customer to explain the problem. In either case, the staff member “S” typically attempts to enter into the computer 15 specific details of the conversation regarding the nature of the problem. This data entry is often performed by the staff member “S” while the conversation is taking place.

As is evident, use of the prior art support system can present several detrimental issues related to its use. Such issues can include confusion and fatigue on the part of the staff member “S” which can lead to incorrect data entry, annoyance of the customer “C,” and unnecessarily long conversations between the staff member and the customer. For example, the performance of manual data entry by the staff member “S” often requires a level of concentration which precludes effective participation in the conversation with the customer “C.”

Such inattention to the conversation on the part of the staff member “S” caused by manual data entry responsibilities can result in situations in which the customer “C” is continually asked to repeat certain information which can annoy and confuse the customer. Another result is that excessive gaps can occur in the conversation on the part of the staff member “S” while data entry is performed. This can cause the staff member “S” and/or the customer “C” to lose track of the conversation which results in further confusion and lost opportunity to collect vital data. The distractions to the staff member “S” caused by the need to manually enter data can also negatively affect the staff member's troubleshooting ability and thus reduce the effectiveness of the staff member in providing customer support services to the customer “C.”

Often the organizations which provide such support services, as well as the customers of the organization, consider such support services to be an important aspect of the overall image of the organization as well as an integral part of the product or service line offered by the organization. Thus, the ability to provide efficient and effective customer support services is of great importance.

What is needed then, is a method and apparatus for providing support services which achieve the benefits to be derived from similar prior art devices, but which avoid the shortcomings and detriments individually associated therewith.

### SUMMARY OF THE INVENTION

The invention includes methods and apparatus for communicating information between a first individual and a second individual. A first signal, in voice format, is received from the first individual and a second signal, in voice format, is received from the second individual. The first and second signals are received and read and both are automatically converted from voice format into text format. The first and second signals are visually displayed as text so that the first individual can simultaneously both read and listen to the words of both individuals as the conversation takes place.

In accordance with a first embodiment of the present invention, a method of communicating information between a first individual and a second individual is disclosed. The method includes receiving both the first and second signals in voice format, as well as automatically converting the signals from voice format into text format. The method also includes distinguishing the first and second signals so as to facilitate differentiation of the two signals when visually displayed as text.

In accordance with a second embodiment of the present invention, a communication apparatus for communicating information between a first individual and a second individual is disclosed. The apparatus comprises a controller configured to receive a first signal in voice format as well as a second signal in voice format. The apparatus also comprises a program configured to automatically convert the first and second signals from voice format into text format. A visual display device is also included in the apparatus and is configured to display the first and second signals as readable text. A first receiver portion can be employed to receive the first signal and a second receiver portion can be employed to receive the second signal.

In accordance with a third embodiment of the present invention, a computer-readable storage medium for use in a computer system having a processor configured to execute computer-executable instructions is disclosed. The storage medium holds computer-executable instructions to read a first signal and a second signal as well as instructions to convert the first and second signals from voice format into text format. The storage medium can be configured to hold computer-executable instructions to display the text format so as to provide visual differentiation between the text originating from the first signal and that of the second signal.

### DESCRIPTION OF THE DRAWINGS

FIG. 1 is a schematic diagram which depicts a prior art customer support system.

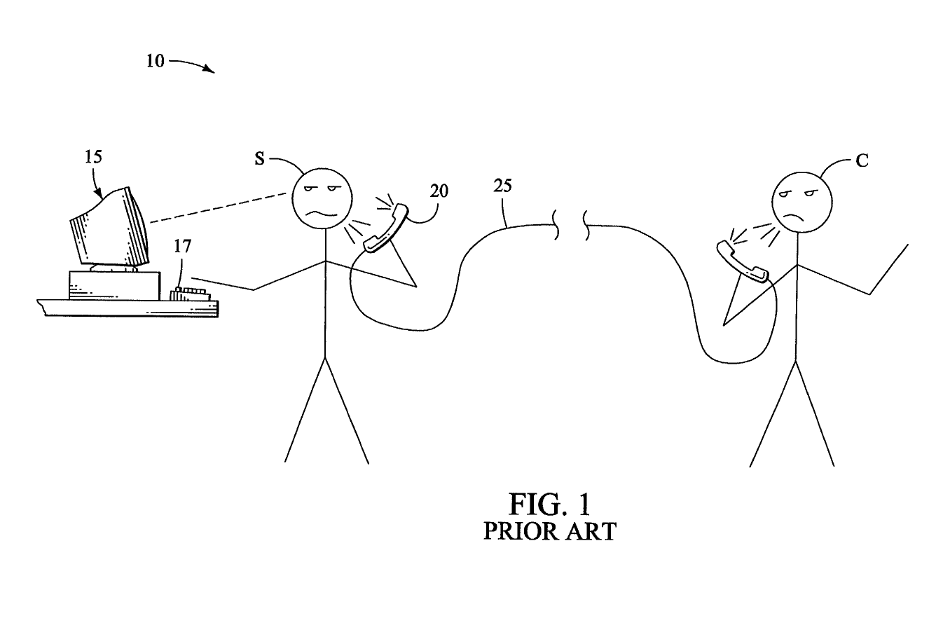

FIG. 2 is a schematic diagram which depicts a communication system in accordance with the first embodiment of the present invention.

FIG. 3 is another schematic diagram which depicts the communication system in accordance with the first embodiment of the present invention.

FIG. 4 is a flow diagram which depicts steps of a method of communicating information via a telecommunication network in accordance with the present invention.

FIG. 5 is a block diagram which depicts several computer-executable instructions that can be held on a computer-readable medium to implement the method of the present invention.

### DETAILED DESCRIPTION OF THE INVENTION

The invention includes methods and apparatus for communicating information between a first individual and a second individual who are conversing remotely via a telecommunication network. In accordance with various aspects of the present invention, a first signal is received from the first individual and a second signal is received from the second individual. The first and second signals are both initially in voice format. The first and second signals are automatically converted from voice format into text format. The first and the second signals are also visually displayed as text so that the first individual can simultaneously both read and listen to the words spoken by both the first and second individuals as the conversation takes place.

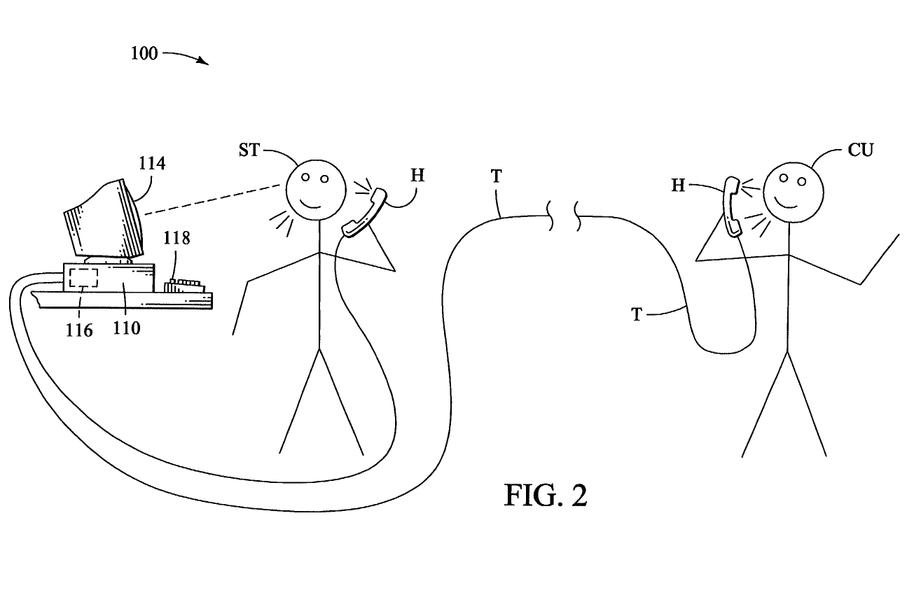

Now moving to FIG. 2, a schematic diagram is shown which depicts an apparatus 100 in accordance with a first embodiment of the present invention. The apparatus 100 is generally employed by a first individual “ST” to effectively and efficiently communicate with a second individual “CU” via a telecommunication system “T.” The apparatus 100 can be particularly well suited for use in a customer support environment wherein the first individual “ST” is a support technician who is a member of a customer support group which is tasked with the responsibility of providing customer support services to the second individual “CU” who is a customer of the support group. The apparatus 100 generally enables the first individual “ST” to provide more efficient and effective customer support services to the second individual “CU” while both individuals are engaged in a conversation.

The apparatus 100 comprises a controller 110 such as a digital processing device or the like. Preferably, the controller 110 is at least a portion of a personal computer or a computer workstation or the like. The apparatus 100 also comprises a visual display device 114 which is in signal communication with the controller 110. When we say “visual display device” we mean any device that is configured to visually display any form of visual text symbols that can be deciphered by the first individual “ST.” For example, the visual display device 114 can be a printer or the like which is configured to print visual text symbols on a print medium such as paper or the like which can be read by the first individual “ST.” Preferably, the visual display device 114 is a visual display screen such as a CRT visual display screen or a liquid crystal visual display screen.

Preferably, the apparatus 100 is configured to be used in conjunction with a telecommunication network “T” so that voice signals can be received remotely from the second individual “CU” via the telecommunication network. The telecommunication network can include any form of telecommunication means such as wire, fiber-optic, microwave, satellite, and the like. The apparatus 100 includes a program 116 comprising a series of computer-executable steps which can be executed by the controller 110 to convert voice signals into text format. Preferably, the program 116 is contained within the controller 110. The apparatus 100 also preferably includes a data entry device 118, such as a keypad or the like, which is configured to allow the first individual “ST” to enter data into the controller 110 or to control various aspects of the operation of the program 116 and the like.

The apparatus 100 is configured to automatically receive data directly from the second individual “CU,” thus freeing the first individual “ST” from the task of audibly receiving and mentally categorizing data from the second individual and then manually entering the data into a data tracking system or the like. More specifically, the apparatus 100 is configured to receive signals from both the first individual “ST” and the second individual “CU.” When we say “signals” we mean analog or digital signals that are generated by an appropriate device, such as a telephone, a keypad, or the like, in response to commands such as spoken vocal signals or typed signals or the like.

When initially received by the apparatus from either the first individual “ST” or the second individual “CU” the signals are preferably in voice format. When we say “voice format” we mean a form of data or signals which represents audible spoken words. The apparatus 100 is further configured to automatically convert the signals from voice format into text format. When we say “automatically convert” we mean that all processes required for the conversion are performed entirely by the controller 110, or other suitable processing device, without the assistance or intervention of human thought processes or analysis.

Thus, “automatically convert” can be contrasted with, for example, the manual conversion of audible speech into written text in the case of what is generally known as “closed captioning” technology. That is, in closed captioning technology, spoken words are manually converted by a stenographer or the like who first hears the spoken words, and then converts the spoken words into written text by way of human thought processes and by way of manipulating a manual data entry device such as a manual keypad or the like. The written text generated by the stenographer in this manner is then displayed on a visual display device such as a display screen or the like in real time as the speaker of the words is uttering them.

Furthermore, closed captioning technology is generally intended to be used to benefit the hearing impaired by providing written text in place of audible speech. That is, closed captioning is generally provided as a substitute for audible speech. The techniques and apparatus for implementing closed captioning technology are well known in the art, and are described, for example, in the book, “Inside Closed Captioning” by Gary D. Robson (ISBN 0-9659609-0-0, 1997 CyberDawg Publishing).

When we say “text format” we mean a form of data or signals which represents written words. That is, the apparatus 100 is configured to receive voice signals which represent audible spoken words and to convert the voice signals into text signals which represent visual text which is substantially a word-for-word transcription of the respective voice signal. The apparatus 100 is further configured to visually display the text signals as readable text which can be read by the first individual “ST” on the display device 114.

Those skilled in the art are familiar with computer software or the like which is capable of performing such conversion of voice signals to text signals. This computer software is often referred to as “speech recognition” or “voice recognition” technology and is available from a number of software publishers. For example, for personal computer applications the program “Dragon Naturally Speaking” is available from Lernot & Hauspie (Belgium). One of many descriptions of such speech recognition technology can be found in U.S. Pat. No. 4,783,803 to Baker, et. al., which is incorporated herein by reference. An example of an apparatus which is configured to receive a stream of voice signals and convert them to text signals for use by a personal computer is the “Text Grabber” manufactured by Sunbelt Industries Technologies Group of Ponte Vedra Beach, Fla.

It is understood that speech recognition technology has not presently reached a state of development so as to be totally accurate. That is, the use of current speech recognition technology often results in somewhat minor errors of grammar, spelling, word recognition, or punctuation. However, it is also understood that the presently available speech recognition technology provides performance which is at a level that is acceptable for use in conjunction with the present invention as described herein.

That is, because the written text generated by speech recognition technology with regard to the present invention is intended only to supplement audible speech, rather than replace it, then the present level of speech recognition technology serves the intended purpose of the present invention. Since the methods and apparatus for performing conversion of voice signals into text signals (such as ASCII text), and subsequently displaying the text signals on a visual display, are well known in the art, we will not describe them further herein other than to explain how such methods and apparatus work in conjunction with the present invention.

Still referring to FIG. 2, a telecommunication network “T,” used in conjunction with the apparatus 100, functions to facilitate an audible conversation between the first and second individuals “ST,” “CU.” That is, signals in voice format are transmitted from both the first individual “ST” and the second individual “CU.” These voice signals substantially represent a conversation taking place between the first and second individuals “ST,” “CU.” As the first individual “ST” speaks into the respective telephone device “H,” the voice of the first individual “ST” is substantially instantaneously converted by the telephone device “H” into a first signal which is in voice format. The first signal is transmitted via a telecommunication network “T” to a telephone device “H” which converts the first signal into an audible signal that is heard by the second individual “CU.”

Likewise, the second individual “CU” speaks into the respective telephone device “H” which substantially instantaneously converts the voice of the second individual into a second signal which is in voice format. The second signal is then substantially instantaneously transmitted via the telecommunication network “T” to the first individual “ST” where the second signal is converted by the respective telephone device “H” into an audible signal which is heard by the first individual. Such transmission and receipt of voice signals between two or more individuals engaged in a conversation comprises a normal function of a telecommunication network “T.”

However, when a telecommunication network “T” is used in conjunction with the apparatus 100, the first and second signals are also received by the apparatus 100 and substantially instantaneously converted into text format and visually displayed as text so that the first individual “ST” can read, as well as listen to, the conversation between the first individual and the second individual “CU.” That is, as the conversation between the first individual “ST” and the second individual “CU” takes place, the audible speech is automatically converted by the apparatus 100 from voice format into text format in substantially real time and is displayed as human-readable text on the display device 114.

The conversation, because it is in text format, can also be stored directly as text in a data storage medium such as a computer-readable storage device. This promotes better concentration on the conversation on the part of the first individual “ST” which, in turn, results in more effective conversational technique and troubleshooting processes on the part of the first individual, as well as promoting efficiency by lessening the average length of conversations between the first individual and the second individual “CU.”

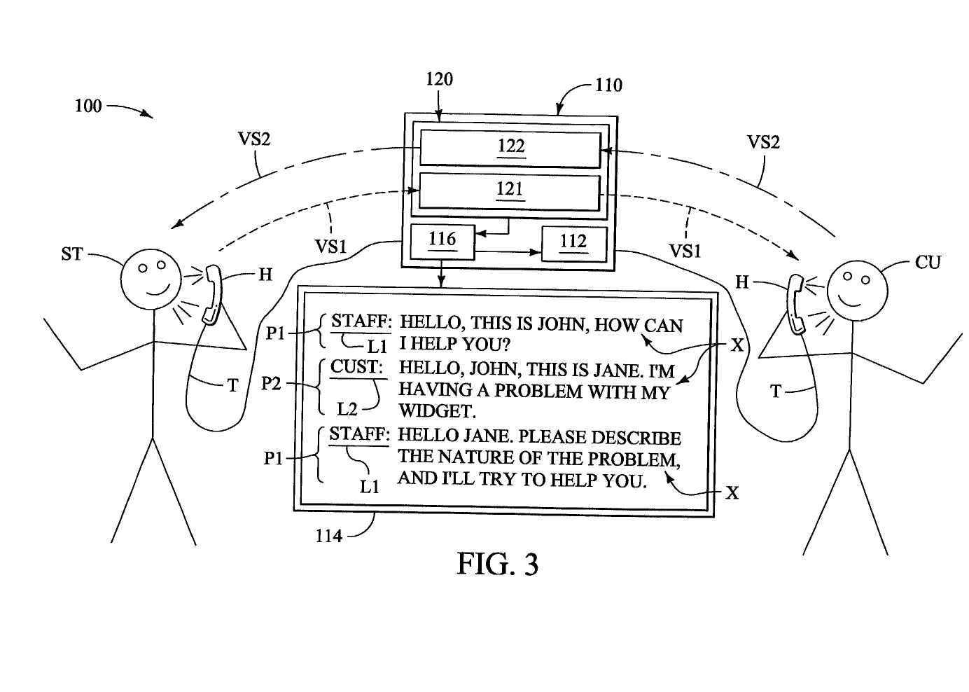

Moving now to FIG. 3, another schematic diagram is shown which depicts the apparatus 100 in accordance with the first embodiment of the present invention. As discussed above, the apparatus 100 comprises a controller 110. The controller 110 is configured to receive signals such as a first signal VS1 and a second signal VS2. As also discussed above, the apparatus 100 includes a program 116 and a visual display device 114. The program 116 preferably employs speech recognition technology in its function of converting signals in voice format into signals in text format. As evident from a study of FIG. 3, the apparatus 100 can also comprise a computer-readable memory device 112 in signal communication with the controller 110 and which is configured to store data.

The computer readable memory device 112 can be, for example, a hard drive, memory modules (micro chips), a magnetic tape read/write device, or other known devices for storing electronic signals, and particularly for storing electronic signals in digital format. It is understood that the readable memory device 112 need not be resident within the controller 110, and can be located at a remote location in signal communication with the controller 110.

When voice-signal conversion technology, such as speech recognition technology, is used to implement the voice signal conversion into text, then the controller 110 further preferably includes any additional components required to perform the conversion, such as encoders, decoders, and the like. The controller 110 is thus considered to include the necessary components for performing the known methods of performing voice-to-text signal conversion and text display processes including such processes inherent in speech recognition technology.

As is evident, the second signal VS2 can be transmitted to the controller 110 via the telecommunication network “T” or the like, and can originate, for example, from the second individual “CU.” The second signal VS2 can ultimately be heard by the first individual “ST” as audible spoken words by way of the respective telephone device “H.” Similarly, the first signal VS1 can originate, for example, from the first individual “ST” and can also be transmitted to the controller 110 via the telecommunication network “T” or the like. The first signal VS1 can ultimately be heard by the second individual “CU” by way of the respective telephone device “H.”Preferably, the first signal VS1 can be transmitted directly to the controller 110 from the telephone device “H” or the like without first being carried by the telecommunication network “T.”

The controller 110 preferably includes a receiver 120 that is configured to detect the first and second signals VS1, VS2 directly from either the telecommunication network “T” or the respective telephone device “H.” By “detect” we mean the general function of sensing a signal which can include receiving, reading, relaying, or the like. After being detected by the receiver 120, the first and second signals VS1, VS2 are processed by the program 116. The program 116 causes the first and second signals VS1, VS2 to be automatically converted from voice format directly into text format by utilizing speech recognition technology or the like. However, the program 116 causes the text format of the first and second signals VS1, VS2 to be distinguishable from one another. This can be accomplished by identifying the source of the signal (i.e. whether it was received via the telecommunication network “T,” or from the respective local telephone device “H” of the first individual “ST”).

The program 116 causes text “X” to be generated on the display device 114 so that the content of the conversation is displayed as human-readable text. When we say “human-readable text” we mean any written textual language that can be understood and deciphered by a human. For example, preferably the conversation between the first individual “ST” is displayed as text and the second individual “CU” can be read and understood by the first individual. Preferably, the program 116 also causes the first and second signals VS1, VS2 to be stored in the computer readable memory device 112. More preferably, the first and second signals VS1, VS2 are stored in the computer readable memory device 112 in text format so that, when retrieved from the computer readable memory device, the signals can generate visual text “X” directly without further conversion.

Preferably, the receiver 120 comprises a first receiver portion 121 as well as a second receiver portion 122. The first receiver portion 121 is configured to detect the first signal VS1 and is preferably further configured to encode, or otherwise differentiate, the first signal so that the program 116 can distinguish the first signal from any other signal. Likewise, the second receiver portion 122 is configured to detect the second voice signal VS2 and is preferably further configured to encode, or otherwise differentiate, the second signal so that the program 116 can distinguish the second signal from any other signal. That is, the first and second receiver portions 121, 122 are preferably configured to facilitate differentiation between the first signal VS1 and the second signal VS2 to enable the program 116 to distinguish between the first and second signals.

The capability of the program 116 to distinguish between the first signal VS1 and the second signal VS2 enables the program to make a first portion P1 of the text “X” visually distinguishable from a second portion P2 of the text “X,” wherein the first portion of the text is spoken by the first individual “ST” and the second portion of the text is spoken by the second individual “CU.” Several alternative methods of distinguishing the first portion P1 from the second portion P2 can be employed by the apparatus 100. For example, the program 116 can assign a first label L1 to first portions P1 of text “X” which are converted from the first signal VS1. Likewise, the program 116 can assign a second label L2 to second portions P2 of text “X” which are converted from the second signal VS2.

That is, the program 116 can cause the first label L1 to be generated and to be visually displayed along with first portions P1 of the text “X” which are spoken by the first individual “ST.” Similarly, the program 116 can cause the second label L2 to be generated and to be visually displayed along with the second portions P2 of the text “X” which are spoken by the second individual “CU.” Preferably, the first and second labels L1, L2 are displayed in a standardized, easy-to-understand way, such as being displayed at the beginning of each respective first and second portion P1, P2 of the text “X.” Such use of the first and second labels L1, L2 facilitate ease of differentiation by a reader between the first portions P1 and second portions P2 of the text “X.”

As is evident, the first and second labels L1, L2 can comprise text. That is, the first and second labels L1, L2 can comprise written words. For example, the first label L1 can comprise the text “Staff” to indicate that the text following the first label has been spoken by the first individual “ST” who can be a staff member of a customer support group. Likewise, the second label L2 can comprise the text “Cust.” to indicate that the text following the second label has been spoken by the second individual “CU” who can be a customer to whom the customer support group is tasked with providing customer support.

Alternatively, the first and second labels L1, L2 can comprise easily-distinguishable non-textual symbols such as graphic symbols or typographical symbols. For example, the first label L1 can comprise the symbol “ [symbol] ” to denote the first individual “ST” who is at the “home office,” while the second label L2 can comprise the symbol “ [symbol] ” to denote a telephone caller such as the second individual “CU.” As a further alternative, the program 116 can be configured to cause the first portions P1 of the text “X” to be visually displayed in a first typographical font, and further configured to cause the second portions of the text “X” to be visually displayed in a second typographical font.

For example, the first portion P1 of the text “X” can be displayed as all-lowercase while the second portion P2 of the text “X” can be displayed as all-uppercase. As yet another example of employing first and second typographical fonts to differentiate first and second portions P1, P2 of text “X,” a font such as “Arial” can be used for first portions of text, while a font such as “Courier” can be used for second portions of text.

In accordance with yet another alternative, when the display device 114 is a display device which is provided with color display capabilities, the program 116 can be configured to cause the first portions P1 of the text “X” to be visually displayed in a first color while causing the second portions P2 of the text to be visually displayed in a second color. For example, the first portion P1 of the text “X” can be displayed as magenta-colored text while the second portion P2 of the text “X” can be displayed as green-colored text. The use of the labels L1, L2 as well as the different text fonts and text colors as described above can facilitate differentiation by a reader between the first portions P1 and the second portions P2 of the text “X.”

Such differentiation between the first and second portions P1, P2 of the text “X,” as provided by utilizing labels L1, L2, different text fonts, and different text colors or the like, can serve to facilitate easier understanding of the conversation by readers of the text. That is, the ease of differentiation between the first and second portions P1, P2 of the text “X” as described above can make it easier for the first individual “ST,” for example, as well as other readers, to follow and understand the conversation because such readers can better understand which individual “ST,” “CU” is speaking which portions P1, P2 of the conversation.

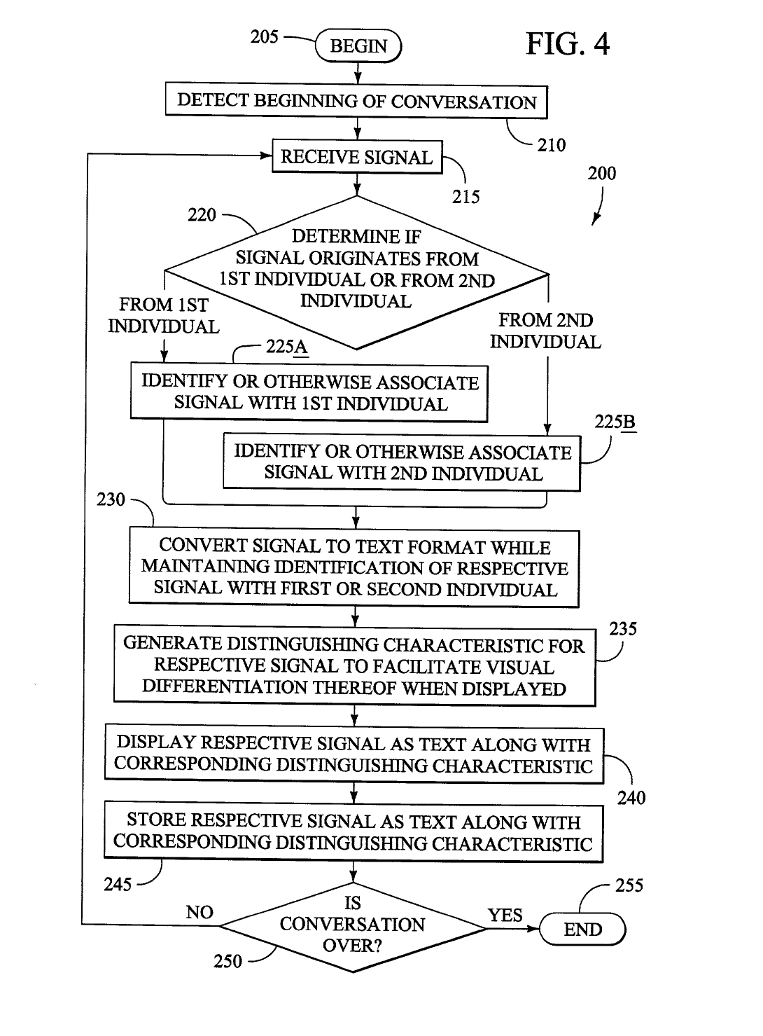

Now moving to FIG. 4, a flow chart 200 is shown which represents various steps of a method of communication between a first individual and a second individual in accordance with a second embodiment of the present invention. The steps of the flow chart can be implemented as a set of computer readable instructions (a “program”), which can be stored in a memory device (such as the memory device 112), which is accessible by the controller 110, and which is executable by the controller in order to implement the method of the present invention. The flow chart 200 represents one possible method of communication while employing the apparatus 100 which is described above in conjunction with FIGS. 2 and 3. As is evident from a study of FIG. 4, the first step 205 of the flow chart 200 is where the method begins.

Moving to the next step 210, the beginning of a conversation between the first individual and the second individual is detected. In accordance with the following step 215, a signal in voice format is received. The voice signal can be a first signal from the first individual or it can be a second signal from the second individual. For example, a signal in voice format from the first individual can contain the phrase, “Customer support, may I help you?” Thus, the next step of the flow chart 200 is a query to determine if the signal received in the previous step 215 originates form the first individual or the second individual. If the signal originates from the first individual, the flow diagram progresses to the first alternative step 225A. However, if the signal originates from the second individual, the flow diagram progresses instead to the second alternative step 225B.

In accordance with the first alternative step 225A, the first signal is identified or otherwise associated with the first individual. That is, the first signal is preferably encoded or otherwise differentiated so as to be identified with the first individual. Similarly, in accordance with the second alternative step 225B, the second signal is identified or otherwise associated with the second individual. In other words, the second signal, since it originates from the second individual, is preferably encoded or otherwise differentiated so as to be identified with the second individual.

After progressing through one of the first or second alternative steps 225A, 225B, the method flows to the next step 230 in which each respective signal is converted to text format while the identification of the respective signal with either the first or second individual, as appropriate, is maintained. After converting the respective signal to text format, the method moves to step 235 in which distinguishing characteristics are generated and associated with the respective signal to facilitate visual differentiation of the signal when displayed as text.

That is, in accordance with step 235, the text format of each respective signal is assigned a distinguishing characteristic so as to differentiate the first and second signals from one another. For example, this can include assigning a first text color to the text format of the first signal, and can further include assigning a second text color to the text format of the second signal. Alternatively, a first typographical font style can be assigned to the first signal, while a second typographical font style can be assigned to the second signal. Additionally, the text can be blocked in contiguous paragraphs from each of the first and the second individuals as shown in FIG. 3.

As seen in FIG. 4, a first label can be assigned to the text format of the first signal while a second label can be assigned to the text format of the second signal in accordance with yet another alternative of step 235. The first and second labels can comprise text, or recognizable words. Alternatively, on in addition, the first and second labels can comprise graphic symbols.

Progressing beyond step 235, the next step of the flow chart 200 is the step 240 wherein the text format of the respective signal is visually displayed as text along with the corresponding distinguishing characteristic. That is, in step 240 a text version of each respective signal is visually displayed substantially simultaneously with an audible transmission of each signal, while the conversation is taking place.

This enables the first individual to read, as well as listen to, the conversation without other distractions associated with prior art methods such as performing data entry functions. In addition, the ability to hear the conversation, as well as to see it as text, can enable the first individual to more clearly formulate an understanding of the information that the second individual is attempting to convey.

Moving past step 240 an optional step 245 is encountered as shown. In accordance with the optional step 245, the respective signal can be stored as it is displayed. The corresponding distinguishing characteristic is preferably stored along with the text format. The storage of the text format of each signal along with the distinguishing characteristic facilitates ease of identification of portions of the conversation with the appropriate individual. That is, when the conversation is stored and then retrieved at a later date, the conversation can be easier to understand if the speaker of each portion of the conversation is plainly identified by the corresponding distinguishing characteristic.

Additionally, in accordance with the optional step 245, the respective text signal can be stored along with the corresponding audible voice signal from which the text signal was generated. This can allow for playback of conversations, or portions thereof, if erroneous voice-to-text translations occur. Also, such storage of the voice signal can provide for subsequent evaluation of the context of the conversation, wherein such context would not normally be evident from only written text. For example, if the either of the first or second individuals who participated in a given conversation were angry or upset, this might be evident only by listening to the audible voice signal of the conversation.

After the optional step 245, the next step is a query 250. The query of step 250 asks if the conversation between the first individual and the second individual is finished. This can be determined, for example, by a disconnect signal generated when the telecommunication network ceases to be in signal communication with the telephone device of the second individual. If the conversation is finished, the flow chart 200 moves to the last step of 255 and the process of performing signal conversion and identification is terminated. If the answer to the query 250 is that the conversation is not over, then the flow chart 200 goes back to step 215 in which another voice signal is received. The flow chart 200 then progresses through the subsequent steps as described above until the query 250 is again reached.

As is evident from a study of FIG. 4 as well as from an understanding of the above explanation of the flow chart 200, the words spoken by each of the first and second individuals are received and then converted into readable text. In addition, the words spoken by the first individual are distinguished from the words spoken by the second individual. That is, the first individual can speak at least one first sentence which is received, identified as a first voice signal, and converted into readable text as the first sentence is spoken. The first sentence is visually displayed in readable text with a first distinguishing characteristic, such as appearing as text in a first color.

When the first individual has finished speaking, the second individual then begins to speak at least one second sentence. The second sentence is received and identified as a second voice signal and converted into readable text as it is spoken. The second sentence can then be visually displayed beneath the first sentence. The second sentence is visually displayed in readable text with a distinguishing characteristic that allows the second sentence to be differentiated from the first sentence.

For example, the second sentence can appear as text in a second color so as to facilitate to the reader the association of the first and second individuals with the respective first and second sentences. In other words, the visual text representing the words spoken by each of the first and second individuals is made distinguishable to allow a reader to determine which words were spoken by whom.

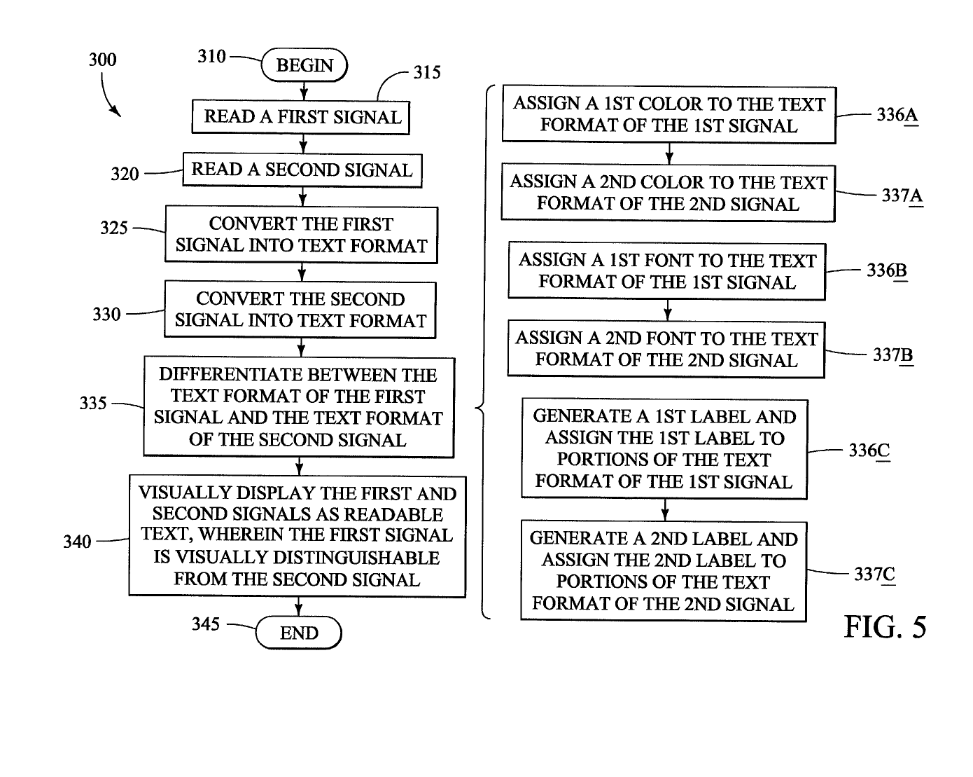

Moving now to FIG. 5, a flow chart 300 is shown which depicts a set of instructions which can be implemented as a series of computer-executable steps which can be held on a computer-readable storage medium. The computer readable medium can be, for example, a diskette, a programmable module or microchip, a compact disk, a hard drive, or any other medium which can retain a computer readable program comprised of the computer executable steps or instructions. The computer executable steps or instructions can be executed, for example, by the controller 110 shown in FIGS. 2 and 3. The invention thus includes a computer readable medium containing a series of computer executable instructions or steps implementing the method of the present invention, as will now be more fully described.

As is seen, the set of instructions 300 have a beginning 310. The first instruction 315 is to read a first signal. The instruction 320 is to read a second signal. The first and second signals can also be temporarily stored in a cache memory or the like while awaiting further processing. Moving to the next instructions 325, 330 the respective first and second signals are converted from voice format into text format. That is, speech recognition technology or the like is employed to convert both the first signal and the second signal from voice format into text format.

After reading and converting the first and second signals from voice format to text format, an instruction 335 is presented to differentiate between the text format of the first voice signal and the text format of the second signal. That is, in accordance with the instruction 335 the text format of the first voice signal is to be distinguished from the voice signal of the text format of the second voice signal. As is seen from a study of FIG. 5, the instruction 335 can comprise one or more pairs of instructions.

For example, the instruction 335 can comprise the instructions 336A and 337A which are, respectively, to assign a first color to the text format of the first voice signal, and to assign a second color to the text format of the second voice signal. Likewise, the instruction 335 can comprise the instructions 336B and 337B which are, respectively, to assign a first font to the text format of the first voice signal, and to assign a second font to the text format of the second voice signal.

Similarly, the instruction 335 can comprise the instructions 336C and 337C which are, respectively, to generate a first label and assign the first label to portions of the text format of the first voice signal, and to generate a second label and assign the second label to portions of the text format of the second voice signal. The first label can comprise text. Alternatively, the first label can comprise a graphic symbol.

Moving to the instruction 340, the first and the second signals are visually displayed as readable text. Moreover, the readable text is configured so that the first signal is distinguishable from the second signal when both are displayed as text. Finally, the instruction 345 marks the end of the block diagram 300. The invention further includes a method for communicating information between a first individual, who can be a support technician, and a second individual, who can be a customer.

The method includes receiving a first signal in voice format from the first individual and automatically converting the first signal directly from voice format into text format. Also, a second signal is similarly received in voice format from the second individual and automatically converted directly from voice format into text format. At least the second signal can be remotely received from the second individual via a telecommunication network.

Preferably, the method includes distinguishing the first signal from the second signal so that the speech of the first individual and the second individual can be similarly distinguished by a reader of the text. Thus, the first signal can be visually displayed as first portions of text while also visually displaying the second signal as second portions of text. To assist in distinguishing the speech of the first individual from that of the second individual, a first label is preferably assigned to the first signal while assigning a second label to the second signal. More preferably, the first label is visually displayed with the first portions of text while the second label is visually displayed with the second portions of text.

As an alternative to, or in addition to, visually displaying first and second labels for distinguishing the speech of the first and second individuals, the first and second portions of text can be visually displayed in respective first and second colors. As yet another alternative, the first and second portions of text can be visually displayed in respective first and second typographical fonts.

The method can further comprise storing the first and second signals in text format for retrieval at a later date. Preferably, the text format of the converted first and second signal comprise electronic signals representative of the text format. Also, a readable memory device is preferably provided for storing thereon at least a portion of the electronic signals which represent the text format.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method of communicating information between a first individual and a second individual, comprising:
receiving a first signal in voice format from the first individual;
automatically converting the first signal directly from voice format into text format;
receiving a second signal in voice format from the second individual;
automatically converting the second signal directly from voice format into text format.

2. The method of claim 1, and wherein the second signal is remotely received from the second individual via a telecommunications network.

3. The method of claim 1, and further comprising distinguishing the first signal from the second signal.

4. The method of claim 1, and further comprising:
visually displaying the first signal as first portions of text; and,
visually displaying the second signal as second portions of text.

5. The method of claim 4, and further comprising:
assigning a first label to the first signal; and,
assigning a second label to the second signal.

6. The method of claim 5, and further comprising:
visually displaying the first label with the first portions of text; and,
visually displaying the second label with the second portions of text.

7. The method of claim 1, and further comprising:
storing the first signal in text format; and,
storing the second signal in text format.

8. The method of claim 7, and wherein the text format of the converted first and second signals comprises electronic signals representative of the text format, the method further comprising providing a readable memory device, and storing thereon at least a portion of the electronic signals representing the text format.

9. The method of claim 4, and wherein:
the first portions of text are visually displayed in a first color; and,
the second portions of text are visually displayed in a second color.

10. The method of claim 4, and wherein:
the first portions of text are visually displayed in a first typographical font; and,
the second portions of text are visually displayed in a second typographical font.

11. A communication apparatus, comprising:
a controller configured to receive a first signal in voice format and also configured to receive a second signal in voice format;
a program comprising a series of computer-executable steps which can be executed by the controller to automatically convert the first signal directly from voice format into text format and to automatically convert the second signal from voice format into text format; and,
a visual display device in signal communication with the controller and configured to visually display the first signal as text and to visually display the second signal as text.

12. The apparatus of claim 11, and further comprising a receiver configured to detect the first signal and the second signal and further configured to enable the program to distinguish between the first signal and the second signal.

13. The apparatus of claim 12, and wherein the receiver comprises a first portion configured to detect the first signal and a second portion configured to detect the second signal.

14. The apparatus of claim 11, and wherein the apparatus is configured to be used in a customer support environment to facilitate the communication of customer support data via a telecommunication network and between the first individual, who is a support technician, and the second individual, who is a customer.

15. A computer-readable storage medium for use in a computer system having a controller configured to execute computer-executable instructions, the medium holding computer-executable instructions to:
read a first voice signal in voice format;
automatically convert the first signal from voice format into text format;
read a second signal in voice format; and,
automatically convert the second signal from voice format into text format.

16. The computer-readable storage medium of claim 14, and further holding computer-executable instructions to distinguish the first signal from the second signal.

17. A customer support system apparatus comprising:
a telecommunication network;
at least two telephone devices allowing a support technician to transmit at least one first signal in voice format, and allowing a customer to transmit at least one second signal in voice format via the telecommunication network;
a receiver configured to detect the first and second signals;
a controller configured to automatically convert the first and second signals from voice format into text format and to generate human-readable text substantially representative of the first and second signals; and,
a visual display device configured to visually display the human-readable text to the support technician.

18. The apparatus of claim 17, and wherein:
the human-readable text comprises a first portion which is generated form the first signals, and a second portion which is generated form the second signals; and,
the controller is further configured to differentiate between the first signals and the second signals, and to generate distinguishing characteristics of the respective first and second portions of the human-readable text to correspondingly identify such with the respective support technician and the customer.

19. The apparatus of claim 17, and wherein the controller converts the first and second signals into human-readable text by employing speech recognition technology.

20. The apparatus of claim 17, and further comprising a computer readable memory device, and further wherein the first and second signals are automatically converted by the controller into digital electronic signals, and further wherein the controller is configured to store the first and second signals in text format on the computer readable memory device.
